(19) United States
(12) Patent Application Publication
(10) Pub. No.: US 2017/0187876 A1
(43) Pub. Date: Jun. 29, 2017

(54) REMOTE AUTOMATED SPEECH TO TEXT INCLUDING EDITING IN REAL-TIME ("RASTER") SYSTEMS AND METHODS FOR USING THE SAME

(71) Applicants: Peter Hayes, Clearwater, FL (US); Ian Blenke, Clearwater, FL (US)

(72) Inventors: Peter Hayes, Clearwater, FL (US); Ian Blenke, Clearwater, FL (US)

(21) Appl. No.: 15/392,773

(22) Filed: Dec. 28, 2016

Related U.S. Application Data
(60) Provisional application No. 62/271,552, filed on Dec. 28, 2015.

(51) Int. Cl. H04M 3/42; H04N 7/088; H04M 3/56; H04N 7/14; G10L 15/26; G10L 21/10

(52) U.S. Cl. CPC H04M 3/42391; G10L 15/26; G10L 21/10; H04M 3/56; H04N 7/147; H04N 7/0882; G10L 2021/065

(57) ABSTRACT

Remote automated speech to text with editing in real-time systems, and methods for using the same, are described herein. Communications between two or more endpoints are established, and audio and/or video data is transmitted there between. Text data representing the audio data, for example, may be generated, and provided the endpoint that formulated the audio data. That endpoint may then edit the text data for clarity and correctness, and the edited text data may then be provided to the receipt endpoint(s).

### CROSS REFERENCE TO RELATED APPLICATION

This application claims benefit to U.S. Provisional Patent Application No. 62/271,552 filed on Dec. 28, 2015.

### FIELD OF THE INVENTION

This disclosure generally relates to remote automated speech to text with editing in real-time systems, and methods for using the same.

### BACKGROUND OF THE INVENTION

The number of systems and devices available to individuals suffering from hearing impairments that enable telephone and video communications is, sadly, limited. Currently, individuals suffering from hearing impairments often use a TTY device. A TTY device allows individuals to communicate by typing messages. Unfortunately, the TTY devices prevent individuals with hearing impairments from conducting a typical phone conversation.

Further exacerbating this problem is that these systems are typically expensive, difficult to operate, and are not robust enough to provide such individuals with the feeling like they are actually conducting a fluid conversation with one or more other individuals (who may or may not also suffering from hearing impairments).

### SUMMARY OF THE INVENTION

Accordingly, it is an objective of the present disclosure to provide remote automated speech-to-text including editing in real-time systems, and methods for using the same.

In one exemplary embodiment, a method for facilitating speech-to-text (“STT”) functionality for a user having hearing impairment is provided. In some embodiments, an electronic device may determine that a first user operating a first user device has initiated a telephone call to a second user operating a second user device. It may then be determined that the second user has answered the telephone call using the second user device. Audio data may then be received at the electronic device from the second user device. A duplicate version of the audio data may then be generated and sent to a remote automated STT device, and the audio data may also be provided to the first user device. Text data may then be generated that may represent the duplicated version of the audio data using STT functionality. The text data may then also be provided to the first user device using real-time-text (“RTT”) functionality. Then, additional audio data may be received that represents a response from the first user to at least one of the audio data and the texted data provided thereto on the first user device.

In another exemplary embodiment, a method for facilitating edited text of video communications for hearing impaired individuals is provided. In some embodiments, an electronic device may determine that a first user operating a first user device has called a second user operating a second user device. The telephone call may then be routed to a video relay system in response to it being determined that the second user device is being called. A video link may then be established between the video relay system, the first user device, and an intermediary device operated by an interpreter. An audio link is established between the intermediary device and the second user device. A first identifier for the intermediary user device may be generated, and a second identifier for the second user device may also be generated. Audio data may then be received from the intermediary user device and or the second user device, and a duplicate version of the audio data from either or both devices may then be generated. The duplicate version of the audio data, the first identifier, and the second identifier may then be provided to the electronic device. Text data representing the duplicate version of the audio data may be generated using speech-to-text (“STT”) functionality. The text data may then be stored in a data repository. At least one of the intermediary device and the second user device may be enabled to edit the text data, and an edited version of the text data may then be provided to the first user device.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1 is an exemplary Teletypewriter (“TTY”) device capable of being used by an individual having a hearing impairment, in accordance with various embodiments;

FIG. 2 is an illustrative diagram of an exemplary system for providing remote automated speech to text for a user, in accordance with various embodiments;

FIG. 3 is an illustrative diagram of an exemplary RASTER system, in accordance with various embodiments;

FIG. 4 is an illustrative diagram of an exemplary system for providing remote automated edited speech to text for multiple users, in accordance with various embodiments;

FIG. 5 is an illustrative diagram of an exemplary system for providing remote automated edited speech to text for multiple users, in accordance with various embodiments;

FIG. 6 is an illustrative diagram of an exemplary system for providing edited speech to text for a video relay service call, in accordance with various embodiments;

FIG. 7A is an illustrative flowchart of a process for providing remote automated edited speech to text in real time, in accordance with various embodiments;

FIG. 7B is an illustrative flowchart continuing the process in FIG. 7A where a user may edit the speech to text, in accordance with various embodiments;

FIG. 8 is an illustrative flowchart of another process for providing edited speech to text for a video relay service call, in accordance with various embodiments; and

FIG. 9 is an illustrative diagram of an exemplary system for providing remote automated edited speech to text for multiple users, in accordance with various embodiments.

### DETAILED DESCRIPTION OF THE INVENTION

The present invention may take form in various components and arrangements of components, and in various techniques, methods, or procedures and arrangements of steps. The referenced drawings are only for the purpose of illustrated embodiments, and are not to be construed as limiting the present invention. Various inventive features are described below that can each be used independently of one another or in combination with other features.

The Remote Automated Speech to Text including Editing in Real-time (RASTER) system uses endpoint software and server software in the communications network to enable one or more of the parties to a telephone or video communication to have their speech converted to text and displayed in real-time to the other party. The speech to text translation is done automatically using computer software without any third party intervention by a human relay operator re-voicing or typing the text. Further, if the speaking party is using the endpoint software or a computer connected to the Internet then the speaking party is able to see and edit their speech to text translation in real-time as it is displayed to the other party. The automated speech to text translation without human intervention and the ability for the parties to the communication to correct the translation directly provides deaf or hard of hearing individuals the same privacy and ability to communicate information accurately that hearing users enjoy. The software endpoint also enables the RASTER system to be used by a single party to convert their speech to text for display to an audience with the ability to edit the text being displayed in real-time.

Telephone call, as used herein, can refer to any means of communication using electronic devices. For example, telephone call can include video chat and conference calls. Persons of ordinary skill in the art recognize that this list is not exhaustive.

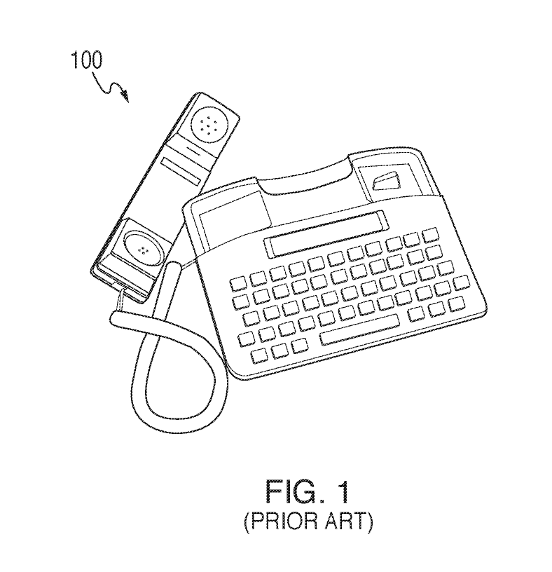

FIG. 1 is an exemplary Teletypewriter (“TTY”) device capable of being used by an individual having a hearing impairment, in accordance with various embodiments. Today's TTY devices, represented here as “TTY device 100,” is large and out of date. If one user in a conversation does not have TTY device 100, a third party operator is used to transcribe the conversation. This makes the conversation less fluid. Moreover, TTY device 100 in some cases, is not user friendly. For example, there is an alarmingly high spelling error rate, some of which is related to malfunctions of keys on TTY device 100. Spelling errors, without correction, can lead to miscommunication between users.

Furthermore, TTY device 100 requires users to know how to type. This is an issue because a large number of TTY device 100 users communicate using American Sign Language (“ASL”). ASL does not have a written counterpart and has a grammatical system which is vastly different from standard English. The requirement of typing can lead to many issues with users who mostly use ASL to communicate.

Lastly, if a user of TTY device 100 is creating a large message, the user receiving the large message must sit and wait until the message is finished and sent. Once the message is finally sent, the receiving user must read the message and respond. This conversation over TTY device 100 is much less fluid than a typical phone conversation. Moreover, the conversation generally takes longer than a typical phone conversation.

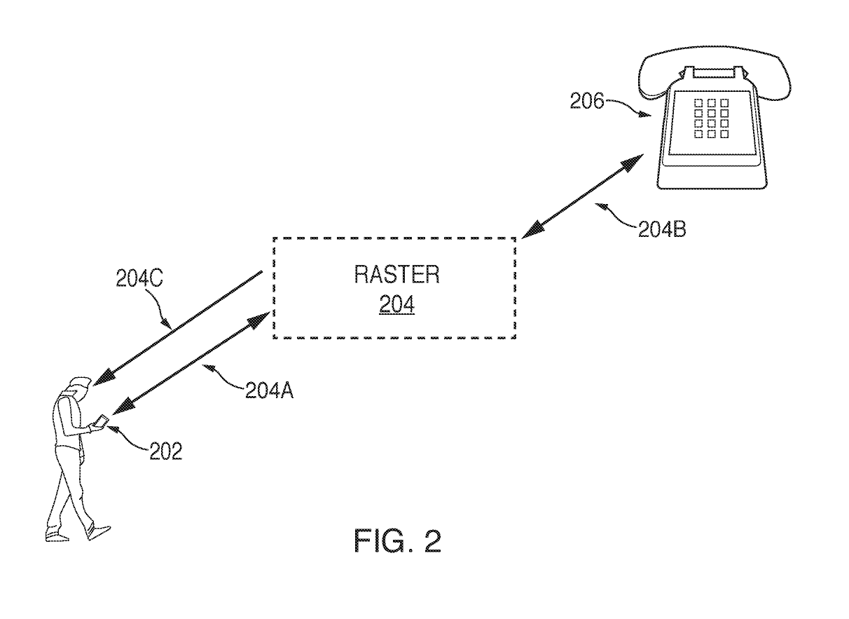

FIG. 2 is an illustrative diagram of an exemplary system for providing remote automated speech to text for a user, in accordance with various embodiments. In some embodiments, first user device 202 may initiate a telephone call with second user device 206. In this embodiment, the user associated with the first user device is hearing impaired. First user device 202 and second user device 206, in some embodiments, may correspond to any electronic device or system. Various types of devices include, but are not limited to, telephones, IP-enabled telephones, portable media players, cellular telephones or smart phones, pocket-sized personal computers, personal digital assistants (“PDAs”), desktop computers, laptop computers, tablet computers, and/or electronic accessory devices such as smart watches and bracelets. In some embodiments, however, first user device 202 and second user device 206 may also correspond to a network of devices.

In some embodiments, first user device 202 may have endpoint software. The endpoint software is able to initiate and complete voice, video, and text communications between parties in different locations using standard communications protocols, including the Session Initiation Protocol (SIP) or WebRTC for voice and video, Real Time Text (RTT) for text communications, and Internet Protocol (IP) or User Datagram Protocol (UDP) for data communications. The endpoint software may also able to automatically launch a Web browser to access Uniform Resource Locator (URL) destinations and will switch automatically between displaying text received in RTT and text displayed on a URL when it receives a URL from a switchboard server controlling the communication. The endpoint software may be downloaded and used on a mobile phone, software phone or computer and is capable of placing SIP calls to telephone numbers or SIP or WebRTC video calls to URL destinations. In some embodiments, the endpoint software may allow a user to request assistance from a third party to help transcribe the telephone conversation.

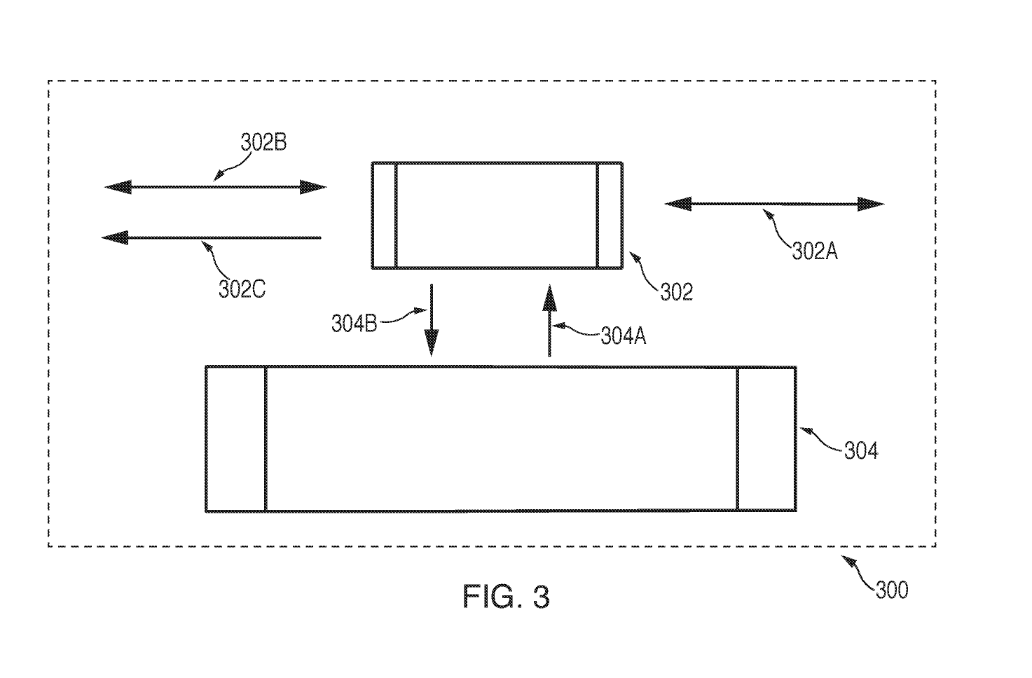

In some embodiments, first user device 202 initiates a telephone call with second user device 206 using endpoint software. The endpoint software, in some embodiments, uses the Session Initiation Protocol (SIP) and Real-time Transport Protocol (RTP) 204A to route first user device's 202 outgoing Internet Protocol (IP) call to RASTER 204. The telephone call may be sent to RASTER 204 over the internet. A more detailed description of RASTER 204 is below in the detailed description of FIG. 3. After a telephone call is initiated, in some embodiments, second user device 206 may answer the telephone call. Once the telephone call is answered, second user device 206 may send first audio data 204B to RASTER 204. In some embodiments, the first audio data may be sent over a PSTN (Public Switched Telephone Network). The first audio data is then processed by RASTER 204, creating first text data representing the first audio data. The first text data is transmitted back to the first user device using real time text functionality 204C such that the text is transmitted as the first audio is transmitted to the first user device 202. After reading and hearing the communications from second user device 206, in some embodiments, first user device 202 may respond.

In some embodiments, RASTER 204 may generate a first identifier for the telephone call that identifies a data storage location and/or specific web page created for that telephone call. The first identifier may be stored on memory of RASTER 204. The memory of RASTER 204 may be referred to as a data repository. Once stored, the first identifier may be sent to first user device 202 and second user device 206. The first identifier may allow a user to access text data representing the audio data on the telephone call. In some embodiments, the first identifier allows a user to access and see text data being created in real time. In some embodiments, the text data may be labelled to show which user is speaking. For example, text representing the first user's audio data may be labelled as “USER 1.” Text representing the second user's audio data may be labelled as “USER 2.” Persons of ordinary skill in the art will recognize that any number of methods may be used to label text data. For example, text data may be labelled by color, numbers, size, spacing, or any other method of differentiating between user audio data. This list is not exhaustive and persons of ordinary skill in the art will recognize that this list is merely exemplary.

In some embodiments, the first text data is also sent to second user device 206, allowing the second user to determine if the first text data is an accurate representation of the first audio data. If, the first text data is inaccurate, first user device 202 and/or second user device 206 may access the first text data using the first identifier. Once the first text data is accessed, it may be edited to fix any inaccuracies. If the first text data is accessed and edited on RASTER 204, RASTER 204 may determine that an edit is being made and transmit the edited text to first user device 202. In some embodiments, edits to the first text data may be in the form of meta data. In some embodiments, edits to the first text data may be in the form of text data.

FIG. 3 is an illustrative diagram of an exemplary RASTER system 300, in accordance with various embodiments. In some embodiments, RASTER system 300 may correspond to RASTER 204. In some embodiments, RASTER system 300 may comprise first processor 302 and second processor 304. In some embodiments, first processor 302 and second processor 304 may include a central processing unit (“CPU”), a graphic processing unit (“GPU”), one or more microprocessors, a digital signal processor, or any other type of processor, or any combination thereof. In some embodiments, the functionality of first processor 302 and second processor 304 may be performed by one or more hardware logic components including, but not limited to, field-programmable gate arrays (“FPGA”), application specific integrated circuits (“ASICs”), application-specific standard products (“ASSPs”), system-on-chip systems (“SOCs”), and/or complex programmable logic devices (“CPLDs”). Furthermore, first processor 302 and second processor 304 may include its own local memory, which may store program data and/or one or more operating systems.

First processor 302 may receive a telephone call from first user device. In some embodiments, this may be accomplished by the Uniform Resource Locator (URL) of first processor 302 receiving the first user device's IP using SIP and RTP 302B. First user device in description of FIG. 3 may be similar to first user device 202 of FIG. 2 and the same description applies. First processor 302, may then route the telephone call from the first user device to a second user device over the PSTN 302A. The second user device in the description of FIG. 3 may be similar to second user device 206, and the same description applies. In some embodiments, first processor 302 may convert the telephone call from IP to Time Division Multiplexing (TDM) for transmission over the PSTN 302A.

After first processor 302 routes the telephone call to the second user device, the second user device, in some embodiments, may send first audio data over the PSTN 302A. In some embodiments, once the first audio data is received, first processor 302 may perform a TDM to IP conversion if needed. First processor 302 may then generate second audio data by duplicating the first audio data. After duplicating the first audio data, first processor 302 may transmit the first audio data to the first user device using SIP and RTP 302B.

In some embodiments, the second audio data may be transmitted 304B from first processor 302 to second processor 304. In some embodiments, transmission of the second audio data may be over the internet or a private network to the URL of second processor 304. Second processor 304 may then generate first text data representing the first audio data using speech to text functionality. The first text data may be transmitted using real time text functionality 304A. Real time text functionality sends generated text as it is made. Generally, this means that second processor 304 may transmit text data to first processor 302 before the second audio data is completely converted to text. In some embodiments, the second audio data is completely translated into text before it is transmitted to first processor 302. As text data is received by first processor 302, first processor 302 may transmit the text data to first user device using real time text functionality 302C.

Once the first user device receives the first audio data and the first text data, the first user device may respond. This response may be transmitted back to first processor 302 using SIP and RTP 302B. First processor 302 may transmit the response to the second user device using PSTN 302A. In some embodiments, before the response is transmitted to the second user device, first processor 302 may convert may convert the response from IP to TDM.

This system may continue to operate until the telephone call has ended.

In some embodiments, first processor 302 and second processor 304 may be one processor. In some embodiments, first processor 302 and second processor 304 may be on an electronic device. In some embodiments first processor 302 and second processor 304 may be one processor on an electronic device.

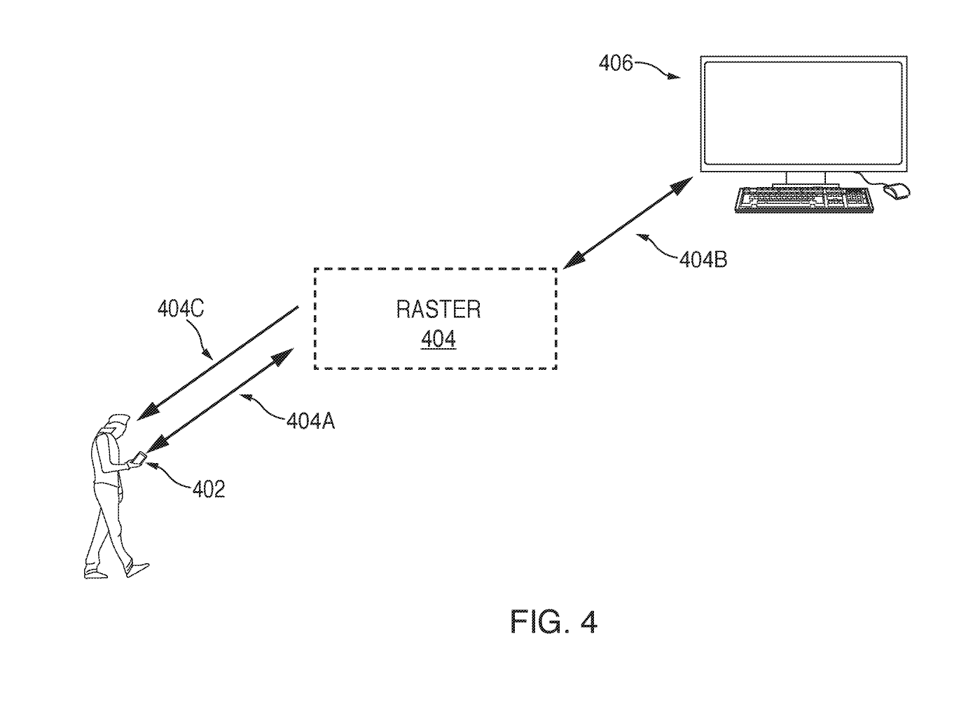

FIG. 4 is an illustrative diagram of an exemplary system for providing remote automated edited speech to text for multiple users, in accordance with various embodiments. In some embodiments, first user device 402 may initiate a telephone call with second user device 406. In this embodiment, the user associated with the first user device is hearing impaired. First user device 402 may be similar to first user device 202 of FIG. 2, and the same description applies. Second user device 406 may be similar to second user device 206 of FIG. 2, and the same description applies. In some embodiments, first user device 402 may have end point software. The endpoint software described herein may be similar to the endpoint software described above in the description of FIG. 2 and the same description applies.

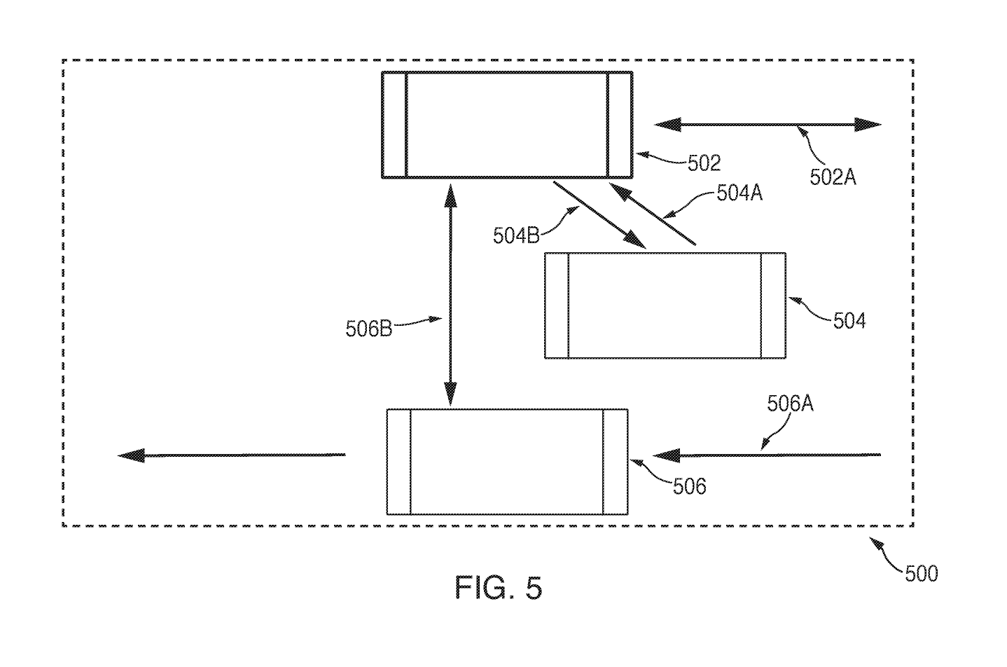

In some embodiments, first user device 402 initiates a telephone call with second user device 406 using endpoint software. The endpoint software, in some embodiments, uses the Session Initiation Protocol (SIP) and Real-time Transport Protocol (RTP) 404A to route first user device's 402 outgoing Internet Protocol (IP) call to RASTER 404. The telephone call may be sent to RASTER 404 over the internet. A more detailed description of RASTER 404 is below in the detailed description of FIG. 5. After a telephone call is initiated, in some embodiments, second user device 406 may answer the telephone call. Once the telephone call is answered, second user device 406 may send first audio data 404B to RASTER 404. In some embodiments, the first audio data may be sent over a PSTN (Public Switched Telephone Network). The first audio data is then processed by RASTER 404, creating first text data representing the first audio data. The first text data is transmitted back to the first user device using real time text functionality 404C such that the text is transmitted as the first audio is transmitted to the first user device 402.

In some embodiments RASTER 404 may generate a first identifier for the telephone call that identifies a data storage location and/or a specific web page created for that call. The first identifier may be stored on memory of RASTER 404. Once stored, the first identifier may be sent to first user device 402. In some embodiments, the first identifier may include a unique URL for the telephone call. In some embodiments, the first identifier may be a unique code for the telephone call. Persons of ordinary skill in the art will recognize that any unique identifier may be used to represent the telephone call.

In some embodiments, once the first identifier is transmitted to first user device 402, the first identifier may be transmitted from first user device 402 to second user device 406. Using the first identifier, second user device 406 may access text representing the first audio. Once second user device 406 has access, second user device 406 may monitor the speech to text translation of first audio in real time. If there is an error in the speech to text translation, second user device 406 may transmit edits 404D in real time. The edited text may then be transmitted to first user device 402 using real time text functionality 404C. In some embodiments, the first identifier is also sent to second user device 406.

In some embodiments, the first text data is also sent to second user device 406, allowing the second user to determine if the first text data is an accurate representation of the first audio data. If, the first text data is inaccurate, first user device 402 and/or second user device 406 may access the first text data using the first identifier. Once the first text data is accessed, it may be edited to fix any inaccuracies. If the first text data is accessed and edited on RASTER 404, RASTER 404 may determine that an edit is being made and transmit the edited text to first user device 402.

In some embodiments, second user device 406 may also have end point software. The endpoint software described herein may be similar to the endpoint software described above in the description of FIG. 2 and the same description applies. If second user device 406 has the end point software, RASTER 404 may generate a second identifier for the telephone call that identifies a data storage location and/or a specific web page created for that call. In some embodiments, the second identifier may be sent to second user device 406. The second identifier may be stored on memory of RASTER 404. Once stored, the second identifier may be sent to second user device 406. In some embodiments, the second identifier may include a unique URL for the telephone call. In some embodiments, the second identifier may be a unique code for the telephone call. Persons of ordinary skill in the art will recognize that any unique identifier may be used to represent the telephone call.

Using the second identifier, second user device 406 may access text representing the first audio. Once second user device 406 has access, second user device 406 may monitor the speech to text translation of audio in real time. If there is an error in the speech to text translation, second user device 406 may transmit edits 404D in real time. The edited text may then be transmitted to first user device 402 using real time text functionality 404C.

In some embodiments, second user device 406 initiates the telephone call with first user device 406. First user device 402, in some embodiments, uses the endpoint software to answer the telephone call initiated by second user device 406. The telephone call may be completed using RASTER 404.

In some embodiments, there may be more than two user devices. The above embodiments can be expanded to include multiple parties to a call. In some embodiments, RASTER 404 hosts the telephone call between more than two user devices.

FIG. 5 is an illustrative diagram of an exemplary system 500 for providing remote automated edited speech to text for multiple users, in accordance with various embodiments. In some embodiments, RASTER system 500 may correspond to RASTER 404. In some embodiments, RASTER system 500 may comprise first processor 502, second processor 504, and third processor 506. First processor 502, second processor 504, and third processor 506 may be similar to first processor 302 and second processor 304 of FIG. 3 and the same description applies.

First processor 502 may receive a telephone call from a first user device. In some embodiments, this may be accomplished by the Uniform Resource Locator (URL) of first processor 502 receiving the first user device's IP using SIP and RTP 502B. First user device in description of FIG. 5 may be similar to first user device 402 of FIG. 4 and the same description applies. First processor 502, may then route the telephone call from the first user device to a second user device over the PSTN 502A. The second user device in the description of FIG. 5 may be similar to second user device 406 of FIG. 5 and the same description applies. In some embodiments, first processor 502 may convert the telephone call from IP to TDM.

After first processor 502 routes the telephone call to the second user device, the second user device, in some embodiments, may send first audio data over the PSTN 502A. In some embodiments, once the first audio data is received, first processor 502 may perform a TDM to IP conversion. First processor 502 may then generate second audio data by duplicating the first audio data. After duplicating the first audio data, first processor 502 may transmit the first audio data to the first user device using SIP and RTP 502B.

Once the first audio data is transmitted to the first user device, first processor 502 may create a first identifier for the telephone call that identifies a data storage location and/or a specific web page created for that call. In some embodiments, the first identifier may include a unique URL for the telephone call. In some embodiments, the first identifier may be a unique code for the telephone call. Persons of ordinary skill in the art will recognize that any unique identifier may be used to represent the telephone call. The first identifier may be transmitted 506B to and stored on third processor 506. Once stored on third processor 506, the first identifier may be transmitted by first processor 502 to the first user device. In some embodiments, the first identifier may also be sent to the second user device.

In some embodiments, the second audio data may be transmitted 504B from first processor 502 to second processor 504. In some embodiments, the second audio data may be transmitted with the first identifier. The transmission of the second audio data, in some embodiments, may be over the internet or a private network to the URL of second processor 504. Second processor 504 may then generate first text data representing the first audio data using speech to text functionality. The first text data may be transmitted using real time text functionality 504A. Real time text functionality sends generated text as it is made. Generally, this means that second processor 504 may transmit text data to first processor 502 before the second audio data is completely converted to text. In some embodiments, the second audio data is completely translated into text before it is transmitted to first processor 502. As text data is received by first processor 502, first processor 502 may transmit the text data to first user device using real time text functionality 502C.

First processor 502, in some embodiments, may create second text data by duplicating the first text data. The second text data may then be transmitted 506B from first processor 502 to third processor 506. Third processor 506 may store the second text data in the data storage location and/or a specific web page created for the telephone call. Third processor 506 may act as a central repository for the text data representing the audio data from the telephone call. Third processor 506 may also receive and store audio data from the telephone call.

Using the first identifier, the second user device may access third processor 506. Third processor 506, in some embodiments, may show the speech to text translation of the audio in real time. In some embodiments, the second user device edits the second text data in real time 506A. The edited text data may be transmitted by third processor 506 may send the edited text to first processor 502. First processor 502 may then send the edited text to the first user device using real time text functionality. In some embodiments, third processor 506 may transmit the edited text to first user device using real time text functionality 506C.

Once the first user device receives the first audio data and the first text data, the first user device may respond. This response may be transmitted back to first processor 502 using SIP and RTP 502B. First processor 502 may transmit the response to the second user device using PSTN 502A. In some embodiments, before the response is transmitted to the second user device, first processor 502 may convert may convert the response from IP to TDM.

This system may continue to operate until the telephone call has ended.

In some embodiments, the first text data is also sent to second user device, allowing the second user to determine if the first text data is an accurate representation of the first audio data.

In some embodiments, first processor 502 may create a second identifier for the telephone call that identifies a data storage location and/or a specific web page created for that call. In some embodiments, the second identifier may include a unique URL for the telephone call. In some embodiments, the second identifier may be a unique code for the telephone call. Persons of ordinary skill in the art will recognize that any unique identifier may be used to represent the telephone call. The second identifier may be transmitted 506B to and stored on third processor 506. Once stored on third processor 506, the second identifier may be transmitted by first processor 502 to the second user device. In some embodiments, the second identifier may also be sent to the first user device.

Using the second identifier, second user device 406 may access text representing the first audio. Once second user device 406 has access, second user device 406 may monitor the speech to text translation of audio in real time. If there is an error in the speech to text translation, second user device 406 may transmit edits 404D in real time. The edited text may then be transmitted to first user device 402 using real time text functionality 404C.

In some embodiments, first processor 502, second processor 504, and third processor 506 may be one processor. In some embodiments, first processor 502, second processor 504, and third processor 506 may be on an electronic device. In some embodiments first processor 502, second processor 504, and third processor 506 may be one processor on an electronic device.

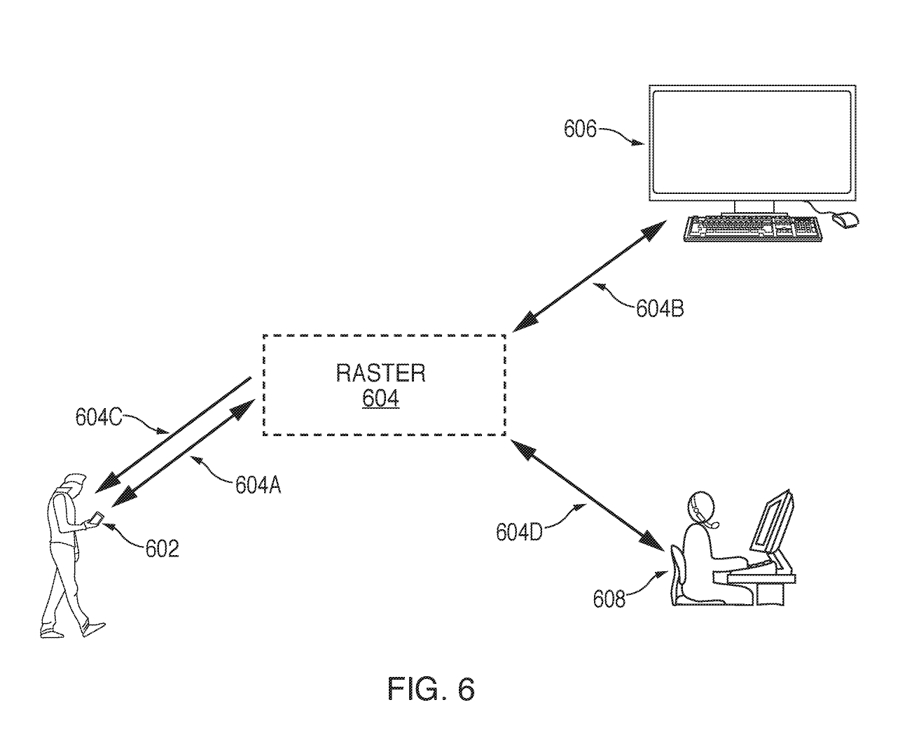

FIG. 6 is an illustrative diagram of an exemplary system for providing edited speech to text for a video relay service call, in accordance with various embodiments. In some embodiments, second user device 606 may initiate a telephone call with first user device 602. In this embodiment, the user associated with the first user device 602 is deaf. The number associated with first user device 602 is listed in the Telecommunications Relay Service User Registration Database, so the telephone call from second user device 606 will be routed to the first user device's 602 Video Relay Service (VRS) provider. The VRS provider will establish a video link between first user device 602, and third user device 608. Third user device 608 is associated with a user who is a sign language interpreter who will relay the communication from second user device 606.

First user device 602 may be similar to first user device 202 of FIG. 2, and the same description applies. Second user device 606 may be similar to second user device 206 of FIG. 2, and the same description applies. Third user device 608 may be similar to first user device 202 and second user device 206 of FIG. 2 and the same description applies. In some embodiments, first user device 602 and third user device 608 have cameras. In some embodiments, first user device 602 and third user device 608 may have end point software. The endpoint software described herein may be similar to the endpoint software described above in the description of FIG. 2 and the same description applies.

In some embodiments, the telephone call initiated by second user device 606 is routed to first user device using PSTN 604B. After the call is initiated, RASTER 604 establishes a video link between third user device 608 and first user device 602. RASTER 604 may be similar to RASTER system 500 of FIG. 5 and the same description applies. RASTER 604 may then create a first identifier and a second identifier. The first and second identifiers herein may be similar to the first and second identifiers described in FIG. 5, and the same description applies. The first and identifiers may be stored on memory of RASTER 604.

During the telephone call, second user device 606 sends first audio data using PSTN 604B. After receiving the first audio data, RASTER 604 may generate second audio data by duplicating the first audio data. After duplicating the first audio data, in some embodiments, the first audio data may be transmitted to first user device 602 using SIP or RTP 604A. In some embodiments, RASTER 604 may then translate the second audio data into first text data. RASTER 604, in some embodiments, may generate second text data by duplicating the first text data. The first text data, in some embodiments may be transmitted to first user device 602 using real time text functionality 604C. The second text data, in some embodiments, may be stored in the location identified by the first and second identifiers.

In some embodiments, once the first identifier is transmitted to first user device 602, the first identifier may be transmitted from first user device 602 to second user device 606. Using the first identifier, second user device 606 may access text representing the first audio. Once second user device 606 has access, second user device 606 may monitor the speech to text translation of audio in real time. If there is an error in the speech to text translation, second user device 606 may transmit edits in real time. The edited text may then be transmitted to first user device 602 using real time text functionality 604C. In some embodiments, the first identifier is also sent to second user device 606.

During the telephone call, third user device 608 sends third audio data 604D to RASTER 604. After receiving the third audio data, RASTER 604 may generate fourth audio data by duplicating the third audio data. After duplicating the third audio data, in some embodiments, the third audio data may be transmitted to first user device 602 using SIP or RTP 604A. In some embodiments, RASTER 604 may then translate the fourth audio data into third text data. RASTER 604, in some embodiments, may generate fourth text data by duplicating the third text data. The third text data, in some embodiments may be transmitted to first user device 602 using real time text functionality 604C. The fourth text data, in some embodiments, may be stored in the location identified by the first and second identifiers.

In some embodiments, the second identifier is transmitted to third user device 608. Using the second identifier, third user device 608 may access text representing the third audio. Once third user device 608 has access, third user device 608 may monitor the speech to text translation of audio in real time. If there is an error in the speech to text translation, the third user device 608 may transmit edits in real time. The edited text may then be transmitted to first user device 602 using real time text functionality 604C. In some embodiments, the second identifier is also sent to second user device 606. Second user device 606 may also edit text representing audio from third user device 608.

In some embodiments, the RASTER system may be utilized with only one user device. For example, if a professor is teaching a class and wants to edit the text of his or her speech displayed to the students, the professor may use the RASTER system to edit text displayed to his or her students. The RASTER system in this embodiment may be similar to the RASTER systems described in FIGS. 2-6 and the same description applies.

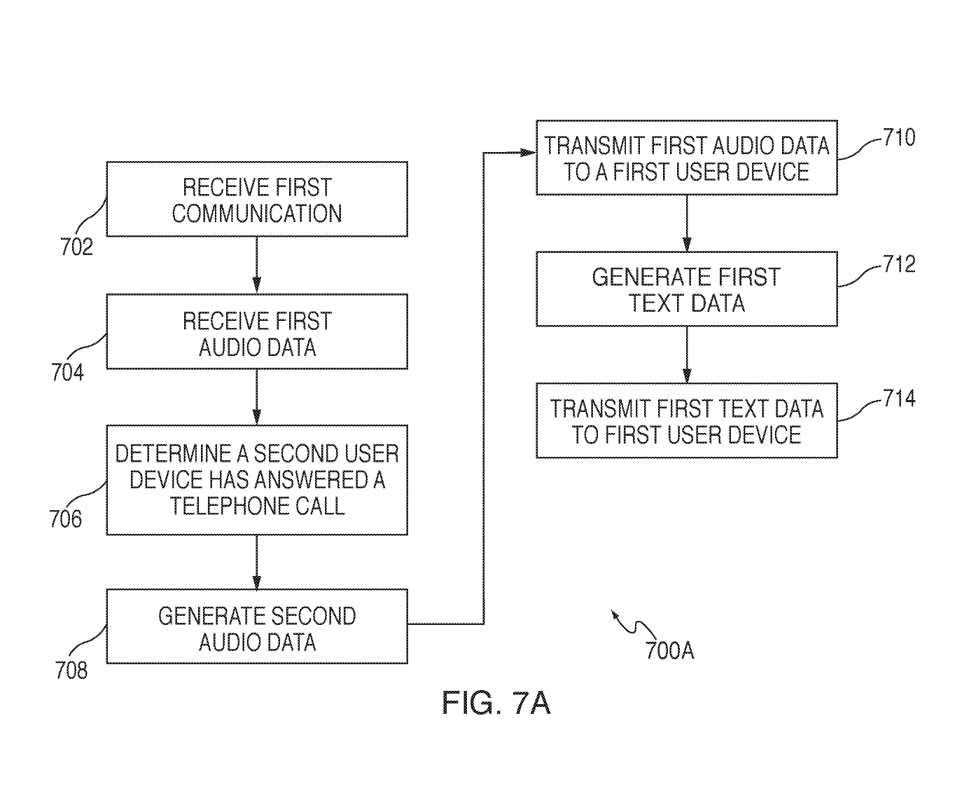

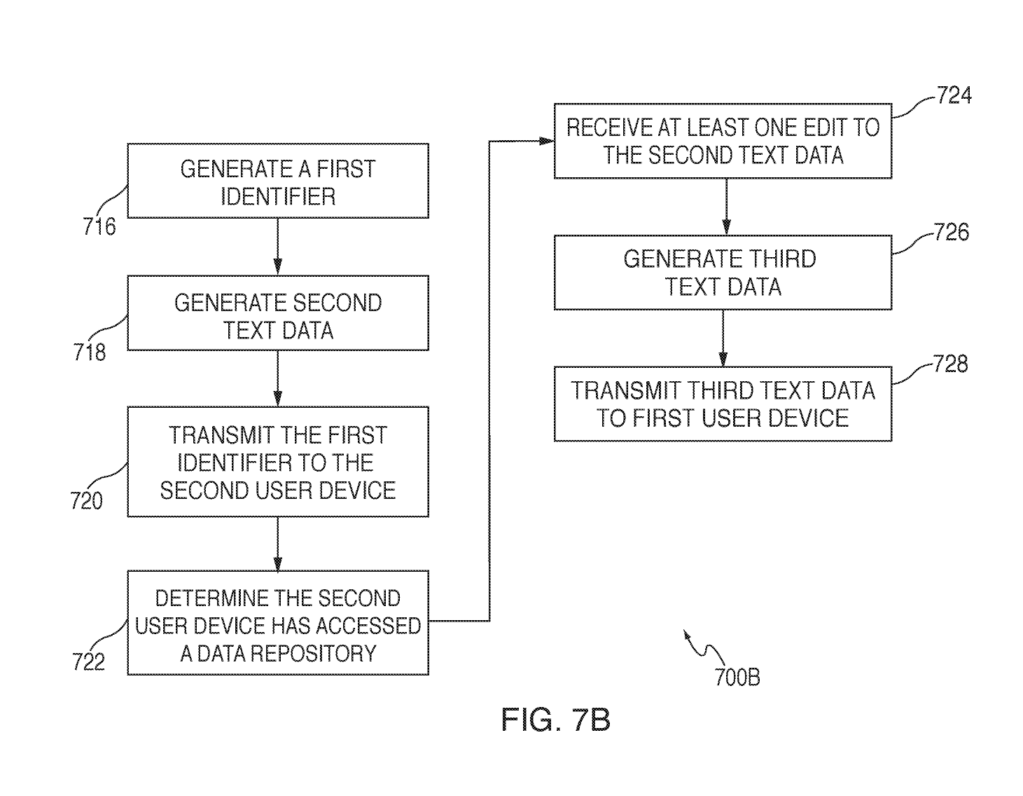

FIG. 7A is an illustrative flowchart of process 700A for providing remote automated edited speech to text in real time. Process 700A uses terms and systems described throughout this application, the descriptions of which apply herein. Persons of ordinary skill in the art will recognize that, in some embodiments, steps within process 700A may be rearranged or omitted. In some embodiments, process 700A may begin at step 702. At step 702, an electronic device receives a first communication data. The electronic device described in process 700A may refer to the RASTER system of FIGS. 2-6 and the same descriptions apply. The first communication data may indicate that a telephone call between a first user device associated with a first user is being initiated with a second user device associated with a second user. In some embodiments, this may be accomplished by the Uniform Resource Locator (URL) the electronic device receiving the first user device's IP using SIP and RTP.

In some embodiments, a user with hearing disabilities may be initiating a telephone call with another user. The first user device described herein may be similar to first user device 202 of FIG. 2 and the same description applies. The first user device described herein may, in some embodiments, have endpoint software similar to the endpoint software described in FIGS. 2-6, and the same descriptions apply. The second user device described herein may be similar to second user device 206 of FIG. 2 and the same description applies.

The electronic device may route the telephone call from the first user device to the second user device over the PSTN. In some embodiments, the electronic device may convert the telephone call from IP to TDM.

At step 704 the electronic device receives first audio data. The first audio data, in some embodiments, may be received from the second user device using PSTN. In some embodiments, the first audio data may represent the second user speaking into the second user device. In some embodiments, once the first audio data is received, the electronic device may perform a TDM to IP conversion.

At step 706 the electronic device determines a second user device has answered the telephone call. Once audio data has been received from the second user device, the electronic device determines that the call has been answered by the second user device.

At step 708 the electronic device generates second audio data. Once the first audio data has been received over the PSTN, the electronic device may generate second audio data by duplicating the first audio data. For example, if the second user device sends audio data to the electronic device, the original audio data may be duplicated.

At step 710, the electronic device transmits the first audio data to the first user device. In some embodiments, the electronic device may transmit the first audio data to the first user device using SIP and RTP 302B. For example, if the second user device sends audio data to the electronic device, the original audio may be transmitted to the first user device.

At step 712, the electronic device generates first text data. Once the first audio data is duplicated, the duplicated audio data may be translated into first text data using speech to text functionality. The generated first text data, in some embodiments, may represent the first audio data sent by the second user device.

At step 714, the electronic device transmits the first text data to the first user device. Once the text data is created, the electronic device may transmit the first text data to the first user device using real time text functionality.

In some embodiments, the electronic device may receive at least one edit to the first text data. The at least one edit may be received from the first user device or the second user device. Once the electronic device has received at least one edit, the electronic device may generate second text data based on the first text data and the at least one edit. The second text data, in some embodiments, may be transmitted to the first user device using real time text functionality.

FIG. 7B is an illustrative flowchart continuing the process in FIG. 7A where a user may edit the speech to text. Process 700B uses terms and systems described throughout this application, the descriptions of which apply herein. Persons of ordinary skill in the art will recognize that, in some embodiments, steps within process 700B may be rearranged or omitted. Process 700B may continue process 700A at step 716. At step 716, the electronic device generates a first identifier. The first identifier may be similar to the first identifier described in FIGS. 2-6 and the same description applies.

At step 718, the electronic device generates second text data. In some embodiments, the electronic device may generate second text data by duplicating the first text data. The second text data, in some embodiments, may be stored on a data repository of the electronic device. The stored second text data may be edited by either the first user device or the second user device. The edited text may also be transmitted to the first user device.

At step 720, the electronic device transmits the first identifier to the second user device. The first identifier allows the second user device to access the second text data. In some embodiments, the first identifier may be transmitted to the first user device. After the first user device has received the first identifier, the first user device may transmit the first identifier to the second user device.

At step 722, the electronic device determines that the second user device has accessed the data repository that has stored the second text data. To access the data repository, the second user device may use the first identifier. Once the first identifier has been entered, the electronic device may determine that the second user device has accessed the data repository.

At step 724, the electronic device receives at least one edit to the second text data. Once the second user device has access to the stored second text data, the second user device may make one or more edits to the second text data. For example, if the text representing the second audio data has made a mistake, the second user device may correct that mistake.

At step 726, the electronic device generates third text data. After receiving at least one edit, the electronic device generates text data reflecting those change(s). In some embodiments, the electronic device generates third text based on the second text and the at least one edit.

At step 728, the electronic device transmits the third text data to the first user device. Once the third text has been generated, the third text is transmitted to the first user device using real time text functionality.

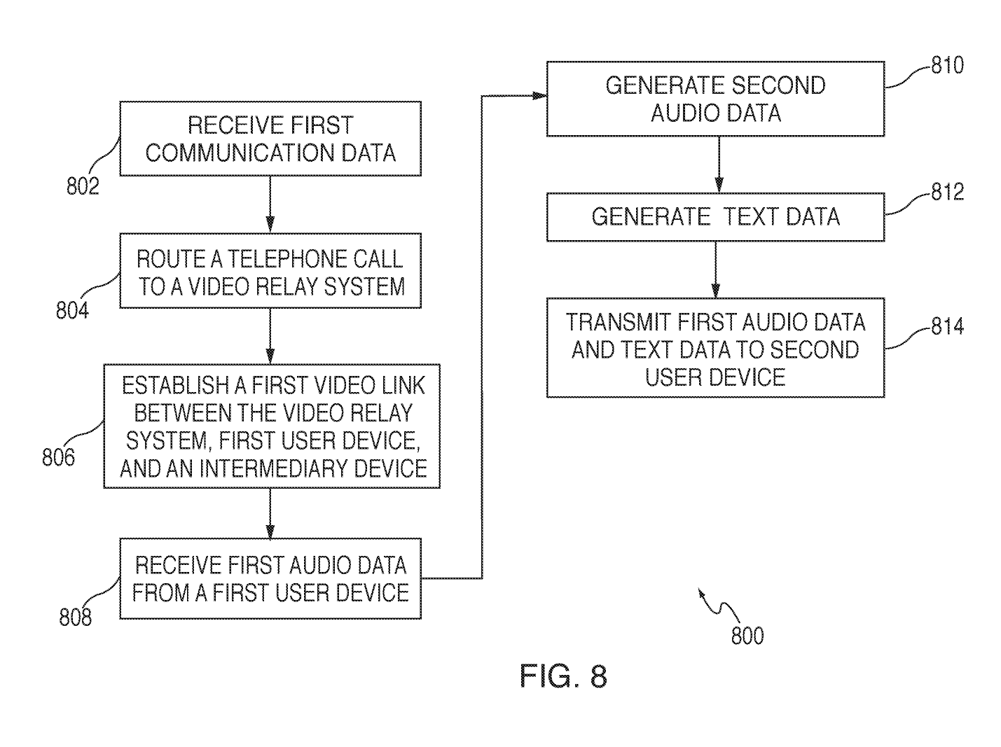

FIG. 8 is an illustrative flowchart of process 800 for providing edited speech to text for a video relay service call, in accordance with various embodiments. Process 800 uses terms and systems described throughout this application, the descriptions of which apply herein. Persons of ordinary skill in the art will recognize that, in some embodiments, steps within process 800 may be rearranged or omitted. Process 800 may begin at step 802. At step 802, an electronic device receives a first communication data. The electronic device described in process 800 may refer to the RASTER system of FIGS. 2-6 and the same descriptions apply. The first communication data may indicate that a telephone call between a first user device associated with a first user is being initiated with a second user device associated with a second user. In some embodiments, this may be accomplished by the Uniform Resource Locator (URL) the electronic device receiving the first user device's IP using SIP and RTP.

In some embodiments, a user who is deaf may be initiating a telephone call with another user. The first user device described herein may be similar to first user device 202 of FIG. 2 and the same description applies. The first user device and second user device may have at least one camera. The first user device described herein may, in some embodiments, have endpoint software similar to the endpoint software described in FIGS. 2-6, and the same descriptions apply. The second user device described herein may be similar to second user device 206 of FIG. 2 and the same description applies.

The electronic device may route the telephone call from the first user device to the second user device over the PSTN. In some embodiments, the electronic device may convert the telephone call from IP to TDM.

At step 804, the electronic device routes the telephone call to a video relay system. Step 804 is similar to the description of establishing a connection with a video relay system in FIG. 6 and the same description applies.

At step 806, the electronic device establishes a first video link between the video relay system, the first user device, and an intermediary device. In some embodiments, the intermediary device may be a device associated with a sign language interpreter who will relay the communication from second user device. The intermediary device, in some embodiments, may be similar to third user device 608 of FIG. 6 and the same description applies.

At step 808, the electronic device receives first audio data from the first user device. The first audio data, in some embodiments, may be received from the first user device using PSTN. In some embodiments, the first audio data may represent the first user speaking into the first user device. In some embodiments, once the first audio data is received, the electronic device may perform a TDM to IP conversion or an IP to TDM conversion.

At step 810, the electronic device generates second audio data. Once the first audio data has been received, the electronic device may generate second audio data by duplicating the first audio data. For example, if the first user device sends audio data to the electronic device, the original audio data may be duplicated.

At step 812, the electronic device generates text data. Once the first audio data is duplicated, the duplicated audio data may be translated into first text data using speech to text functionality. The generated first text data, in some embodiments, may represent the first audio data received by the electronic device.

At step 814, the electronic device transmits the first audio data and text data to the second user device. The original audio received, the first audio data, may be transmitted to the second user device. Additionally, in some embodiments, once the text data is created, the electronic device may transmit the first text data to the second user device using real time text functionality.

In some embodiments, the electronic device may receive at least one edit to the first text data. The at least one edit may be received from the first user device or the second user device. Once the electronic device has received at least one edit, the electronic device may generate second text data based on the first text data and the at least one edit. The second text data, in some embodiments, may be transmitted to the first user device using real time text functionality.

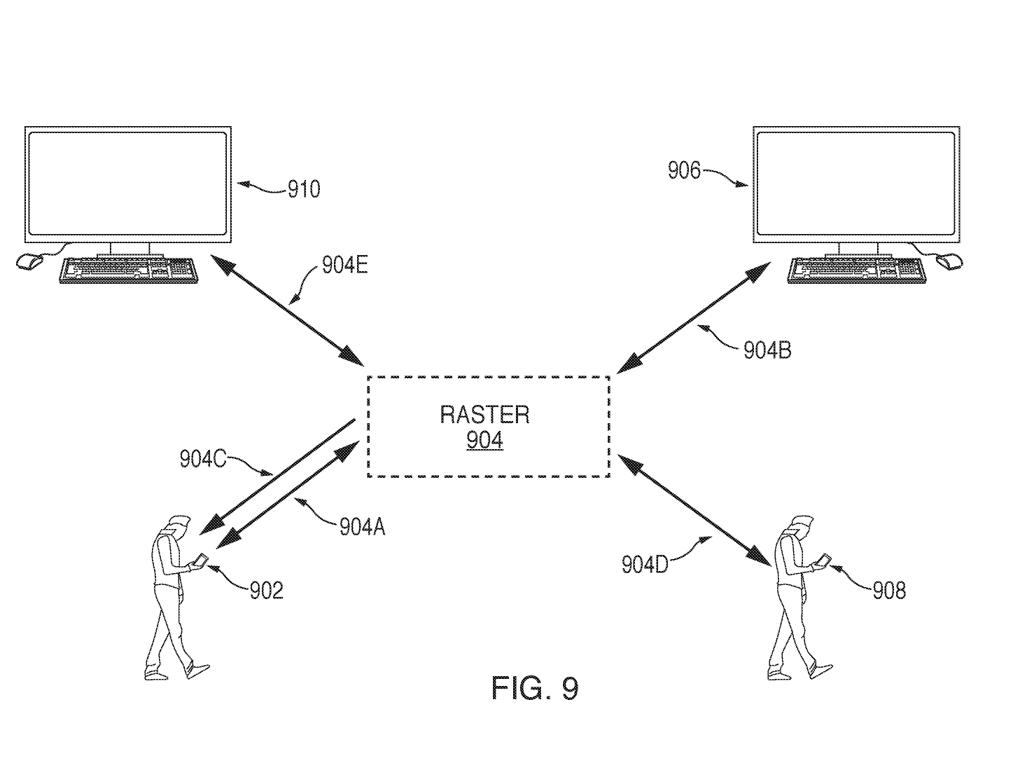

FIG. 9 is an illustrative diagram of an exemplary system for providing remote automated edited speech to text for multiple users, in accordance with various embodiments. In some embodiments, first user device 902 may initiate a conference telephone call with second user device 906, third user device 908, and fourth user device 910. In this embodiment, the user associated with the first user device is hearing impaired. First user device 902, second user device 906, third user device 908, and fourth user device 910 may be similar to first user device 202 and second user device 206 of FIG. 2, and the same descriptions apply. In some embodiments, first user device 902 may have endpoint software. The endpoint software described herein may be similar to the endpoint software described in FIG. 2 and the same description applies.

In some embodiments, first user device 902 initiates a conference telephone call with second user device 906, third user device 908, and fourth user device 910 using endpoint software. The endpoint software, in some embodiments, uses the Session Initiation Protocol (SIP) and Real-time Transport Protocol (RTP) 204A to route first user device's 902 outgoing Internet Protocol (IP) call to RASTER 904. RASTER 904 may be similar to RASTER 500 of FIG. 5 and RASTER 300 of FIG. 3, and the same descriptions apply. The telephone call may be sent to RASTER 904 over the internet. After a conference telephone call is initiated, in some embodiments, second user device 906 may join the conference telephone call. Once the conference telephone call is established, second user device 906 may send first audio data 904B to RASTER 904. In some embodiments, the first audio data may be sent over a PSTN. The first audio data is then processed by RASTER 904, creating first text data representing the first audio data. The first text data is transmitted to the first user device using real time text functionality 904C such that the text is transmitted as the first audio is transmitted to the first user device 902. Moreover, the first audio data may also be transmitted to third user device 908 and fourth user device 910 once they have joined the conference call. After reading and hearing the communications from second user device 906, in some embodiments, first user device 902 may respond.

After first user device 902 responds, in some embodiments, third user device 908 may respond. To respond, third user device 908 may send second audio data 904D to RASTER 904. The second audio data is then processed by RASTER 904, creating second text data representing the second audio data. After creating the second text data, the second audio data may be transmitted to first user device 902, second user device 906, and fourth user device 910. The second text data is transmitted to first user device 902 using real time text functionality 904C.

After third user device 908 responds, in some embodiments, fourth user device 910 may respond. To respond, fourth user device 910 may send third audio data 904E to RASTER 904. The third audio data is then processed by RASTER 904, creating third text data representing the third audio data. After creating the third text data, the third audio data may be transmitted to first user device 902, second user device 906, and third user device 908. The third text data is transmitted to first user device 902 using real time text functionality 904C. In some embodiments, this process may continue in any order among the user devices until the conversation has ended.

In some embodiments, first user device 902, second user device 906, third user device 908 and fourth user device 910 may all have end-point software and may all receive text data corresponding to the first audio, second audio, third audio, and fourth audio data. In such an embodiment, a unique identifier is created for each audio data/text data pair and each unique identifier may be stored on RASTER 904. The identifier may label each user as described in FIG. 2 to enable a hard of hearing user to easily distinguish the text associated with each user on the conference call.

The various embodiments described herein may be implemented using a variety of means including, but not limited to, software, hardware, and/or a combination of software and hardware. The embodiments may also be embodied as computer readable code on a computer readable medium. The computer readable medium may be any data storage device that is capable of storing data that can be read by a computer system. Various types of computer readable media include, but are not limited to, read-only memory, random-access memory, CD-ROMs, DVDs, magnetic tape, or optical data storage devices, or any other type of medium, or any combination thereof. The computer readable medium may be distributed over network-coupled computer systems. Furthermore, the above described embodiments are presented for the purposes of illustration are not to be construed as limitations.

What is claimed is:

1. A method for facilitating speech-to-text functionality for a user having hearing impairment, the method comprising:
receiving, at an electronic device, first communication data indicating that a telephone call between a first user device associated with a first user is being initiated with a second user device associated with a second user;
determining, based on first audio data received from the second user device, that the second user device has answered the telephone call;
generating second audio data, the second audio data being a duplicate of the first audio data;
transmitting the first audio data to the first user device;
generating, using the second audio data, first text data representing the second audio data;
transmitting the first text data to the first user device using real-time-text functionality;
receiving at least one edit to the first text data;
generating, based at least in part on at least the at least one edit and the first text data, second text data; and
transmitting the second text data to the first user device using real time text functionality.

2. The method of claim 1, further comprising:
receiving second communication data indicating that a third user device associated with a third user is joining the telephone call;
receiving third communication data indicating that a fourth user device associated with a fourth user is joining the telephone call;
determining, based on first audio data received from the second user device, that the second user device has answered the telephone call;
receiving third audio data from the third user device;
transmitting the third audio data to at least one of the first user device, the second user device, and the fourth user device;
generating, using the fourth audio data, third text data representing the second audio data;
transmitting, using real-time-text functionality, the third text data to at least one of the first user device, the second user device, and the fourth user device;
receiving at least one edit to the third text data;
generating, based on at least the at least one edit and the third text data, fourth text data; and
transmitting using real-time-text functionality, the fourth text data to at least one of the first user device, the second user device, and the fourth user device.

3. The method of claim 2, further comprising:
transmitting the second text data to a third user device;
causing the second text data to be displayed using at least one of the computer or the second user device.

4. The method of claim 1, further comprising:
generating a first identifier for the telephone call;
storing the first identifier on a data repository associated with the electronic device; and
storing the second text data on the data repository.

5. The method of claim 4, further comprising:
transmitting the first identifier to the second user device; and
determining that the second user device has accessed the data repository.

6. The method of claim 1, wherein receiving first audio data from the second user device further comprises:
receiving the first audio data from a public switched telephone network.

7. The method of claim 1, wherein transmitting the first audio data further comprises:
transmitting the first audio data using at least one of session initiation protocol and real time protocol.

8. The method of claim 1, further comprising, transmitting the first text data to the second user device.

9. The method of claim 1, wherein transmitting the first text data to the first user device further comprises:
transmitting the first text data to a third user device, the third user device being connected to the first user device such that the first text data is capable of being displayed using one of the computer or the first user device.

10. A system comprising:
a first user device;
a second user device; and
at least one processor operable to:
establish a connection between the first user device and the second user device such that the first user device may transmit at least:
audio data; and
text data using real-time-text functionality;
receive first audio data from the first user device;
generate, based on the first audio data, second audio data representing the first audio data;
generate, based on the second audio data, first text data representing the first audio data;
transmit the first audio data to the second user device;
transmit the first text data to the second user device using real-time-text functionality;
receive at least one edit to the first text data;
generate, based on at least the at least one edit and the first text data; second text data; and
transmit the second text data to the first user device using real time text functionality.

11. The system of claim 10, wherein the processor is further operable to:
generate a first identifier for the connection established between the first user device and the second user device.

12. The system of claim 11, further comprising:
memory operable to:
store the first identifier; and
store the first text data.

13. The system of claim 12, wherein the processor is further operable to:
transmit the first identifier to the first user device; and
determine that the first user device has accessed a data repository of the memory.

15. The system of claim 10, wherein the second user device is operable to:
output the first audio data;
display the first text data, such that the first text data is displayed while the first audio data is output by the second user device.

16. The system of claim 10, wherein the processor is further operable to:
establish a connection between the first user device and the second user device such that the second user device may transmit at least:
audio data; and
text data using real-time-text functionality;
receive third audio data from the second user device;
generate, based on the third audio data, fourth audio data representing the third audio data;
generate, based on the fourth audio data, second text data representing the fourth audio data;
transmit the third audio data to the first user device; and
transmit the second text data to the first user device using real-time-text functionality.

17. The system of claim 16, wherein the first user device is operable to:
output the third audio data;
display the second text data, such that the second text data is displayed while the third audio data is output by the first user device.

18. A method for facilitating edited video communications for hearing impaired individuals, the method comprising:
receiving, at an electronic device, first communication data indicating that a telephone call between a first user device associated with a first user is being initiated with a second user device associated with a second user;
routing the first communication data to a video relay system in response to determining that the second user device is being called;
establishing a first video link between the first user device and an intermediary device;
establishing a first audio link between the second user device and an intermediary device;
receiving first audio data from the intermediary device;
generating, based at least in part on the first audio data, second audio data representing the first audio data;
generating, based on the second audio data, first text data representing the first audio data;
transmitting the first audio data to the second user device;
transmitting the first text data to the first user device;
receiving third audio data from the second user device;
generating, based at least in part on the third audio data, fourth audio data representing the third audio data;
generating, based on the fourth audio data, second text data representing the fourth audio data;
transmitting the third audio data to the intermediary device; and
transmitting the second text data to the first user device.

19. The method of claim 18, further comprising:
generating a first identifier for the second user device;
generating a second identifier for the intermediary device;
transmitting the first identifier and the second identifier to the first user device; and
storing the first text data and the second text data within a data repository of the electronic device.

20. The method of claim 19, further comprising:
enabling at least one of the intermediary device and the second user device to edit the text data; and
providing an edited version of the text data to the first user device.

21. A method for facilitating speech-to-text functionality for a user having hearing impairment, the method comprising:
receiving first communication data indicating that a telephone call from a first user device associated with a first user is being initiated;
receiving first audio data from the first user device;
generating second audio data, the second audio data being a duplicate of the first audio data;
transmitting the first audio data to the first user device;
generating, using the second audio data, first text data representing the second audio data; and
transmitting the first text data to the first user device using real-time-text functionality.

22. The method of claim 21, further comprising:
receiving at least one edit to the first text data;
generating, based on at least the at least one edit and the first text data, second text data; and
transmitting the second text data to the first user device using real time text functionality.

23. The method of claim 11, further comprising:
generating a first identifier for the telephone call;
storing the first identifier on a data repository associated with the electronic device; and
storing the second text data on the data repository.

24. The method of claim 23, further comprising:
transmitting the first identifier to the first user device; and
determining that the first user device has accessed the data repository.
